(19) United States
(12) Patent Application Publication
(10) Pub. No.: US 2017/0074105 A1
(43) Pub. Date: Mar. 16, 2017

(54) METHOD FOR PRODUCING A TURBINE ROTOR

(71) Applicant: SIEMENS AKTIENGESELLSCHAFT, MUNCHEN (DE)

(72) Inventors: Ralf Bell, Mulheim an der Ruhr (DE); Gary Griffin, Waxhaw, NC (US); Jeremy Marshall, Clover, NC (US)

(21) Appl. No.: 15/358,101

(22) Filed: Nov. 21, 2016

Related U.S. Application Data
(63) Continuation of application No. 14/181,878, filed on Feb. 17, 2014.

(51) Int. Cl. F01D 5/06; B23K 31/02; B23P 15/00; B23P 6/00

(52) U.S. Cl. CPC F01D 5/063; B23P 6/002; B23K 31/02; B23P 15/006; F05D 2220/31; F05D 2230/10; F05D 2230/30; B23K 2201/001

(57) ABSTRACT

A method of producing a turbine rotor, in particular a steam turbine rotor, is provided. A forged and machined existing steam turbine rotor having partially larger dimensions as dimensions of an intended rotor is provided. The form of the existing rotor is compared with the form of the intended rotor and a position of the intended rotor within the existing rotor is chosen. Material is applied by build-up welding on portions of the existing rotor where not enough material is present for machining the intended rotor at the chosen position. The intended rotor is produced at the chosen position by machining the existing rotor.

### CROSS-REFERENCE TO RELATED APPLICATIONS

This application claims the benefit of U.S. patent application Ser. No. 14/181,878 filed on Feb. 17, 2014, the disclosure of which is hereby incorporated by reference herein.

### FIELD OF INVENTION

The claimed invention refers to a method for producing a turbine rotor, in particular a steam turbine rotor.

### BACKGROUND OF INVENTION

Steam turbine rotors are large components manufactured from forged steel ingots. The size and mechanical properties required of the forging for satisfactory operation require specialized processing that only a few vendors in the world can provide. In order to obtain a new forging from one of the suppliers often takes in excess of a year or more. Accordingly the production of a new turbine rotor is very costly not only in financial terms but also in terms of time.

Steam turbine rotors wear out during their operation. Accordingly, it is necessary to repair worn steam turbine rotors and to return them to service due to the high cost and production time associated with acquiring a new rotor. Rotors can be repaired mechanically, for example, by machining away damaged areas, modifying integral rotors to include separate components, or stress relieving to remove excessive hardness or distortion. In addition, rotors can be repaired by build-up welding and subsequent machining. Similar to the process for obtaining a new rotor, repair of a damaged rotor via rotor welding can be also be a slow and expensive process, which can make large repairs difficult financially. If a repair of a steam turbine rotor is not profitable due to excessive damages, the damaged rotor may be replaced by a spare rotor. Due to the fact, that the waiting period for a forging necessary to produce a new rotor is very long, as already mentioned above, customers often store a spare rotor in order to ensure that they can resume power generation as quickly as possible in case of an unrepairable rotor. However, the stocking of a new replacement rotor is accompanied by large expense.

### SUMMARY OF INVENTION

It is an object to provide an alternative method for producing a turbine rotor of the above-mentioned kind, which is favorable in terms of time and expense.

In order to solve this object, a method for producing a turbine rotor, in particular a steam turbine rotor is provided, said method comprising the steps of:

a) Providing at least one forged and machined existing steam turbine rotor having partially larger dimensions as the dimensions of the intended rotor to be produced;

b) Comparing the form of said at least one existing rotor with the form of the intended rotor and choosing a position of the intended rotor within said at least one existing rotor;

c) Applying material by means of build-up welding on portions of said at least one existing rotor, where not enough material is present for machining the intended rotor at the chosen position; and d) Producing the intended rotor at the chosen position by machining the existing rotor.

Thus, according to the method of the claimed invention a new rotor is produced on the basis of at least one existing rotor, which may be provided in form of a salvaged or spare rotor having predominantly larger dimensions as the dimensions of the intended rotor to be produced. The intended rotor is fitted in the at least one existing rotor by means of a comparison of the form of the at least one existing rotor with the form of the intended rotor in order to choose a favorable position of the intended rotor within said at least one existing rotor, wherein the fitting may be supported by a corresponding computer program. At positions, where not enough material is present for producing the intended rotor at the chosen position by means of machining, additional material is applied by means of build-up welding on the respective portions of the at least one existing rotor. Subsequently, the intended rotor is produced at the chosen position by machining the existing rotor.

Preferably, the choice of the position of the intended rotor within said at least one existing rotor in step b) is made taking into consideration production-orientated aspects, in particular the amount of material to be applied in step c) and/or the amount of material to be machined in step d).

For example, the machining in step d) is performed by means of turning and/or milling and/or grinding.

According to one embodiment, at least two forged and machined existing steam turbine rotors are provided and joined to each other in step a), in particular by means of welding. Accordingly, the new rotor is produced on the basis of two existing rotors, which may be provided in the form of salvaged or spare rotors.

According to another embodiment, one or both of said at least two forged and machined existing steam turbine rotors are shortened prior to their joining in order to create a favorable basis for the production of the new rotor.

### BRIEF DESCRIPTION OF THE DRAWINGS

FIG. 1 illustrates a screenshot of an exemplary schematic illustration of an intended rotor form of a steam turbine rotor to be produced and a form of an existing steam turbine rotor 2 having predominantly larger dimensions as compared to the dimensions of the rotor to be produced 1, in accordance with the disclosure provided herein.

FIG. 2 illustrates a top down view of two existing rotors aligned for producing multiple steam turbine rotors via an embodiment of the intended rotor form, in accordance with the disclosure provided herein.

FIG. 3 illustrates a flowchart for an embodiment of a method for producing a turbine rotor in accordance with the disclosure provided herein.

### DETAILED DESCRIPTION OF INVENTION

The components and materials described hereinafter as making up the various embodiments are intended to be illustrative and not restrictive. Many suitable components and materials that would perform the same or a similar function as the materials described herein are intended to be embraced within the scope of embodiments of the present invention.

In general, the computing systems and devices described herein may be assembled by a number of computing components and circuitry such as, for example, one or more processors (e.g., Intel®, AMD®, Samsung®) in communication with memory or other storage medium. The memory may be Random Access Memory (RAM), flashable or non-flashable Read Only Memory (ROM), hard disk drives, flash drives, or any other types of memory known to persons of ordinary skill in the art and having storing capabilities. The computing systems and devices may also utilize cloud computing technologies to facilitate several functions, e.g., storage capabilities, executing program instruction, etc. The computing systems and devices may further include one or more communication components such as, for example, one or more network interface cards (NIC) or circuitry having analogous functionality, one or more one way or multi-directional ports (e.g., bi-directional auxiliary port, universal serial bus (USB) port, etc.), in addition to other hardware and software necessary to implement wired communication with other devices. The communication components may further include wireless transmitters, a receiver (or an integrated transceiver) that may be coupled to broadcasting hardware of the sorts to implement wireless communication within the system, for example, an infrared transceiver, Bluetooth transceiver, or any other wireless communication know to persons of ordinary skill in the art and useful for facilitating the transfer of information.

Referring now to the drawings wherein the showings are for purposes of illustrating embodiments of the subject matter herein only and not for limiting the same, FIG. 1 illustrates a screenshot of an exemplary schematic illustration of an intended rotor form 1 of a steam turbine rotor to be produced and a form of an existing steam turbine rotor 2 having predominantly larger dimensions as compared to the dimensions of the rotor to be produced.

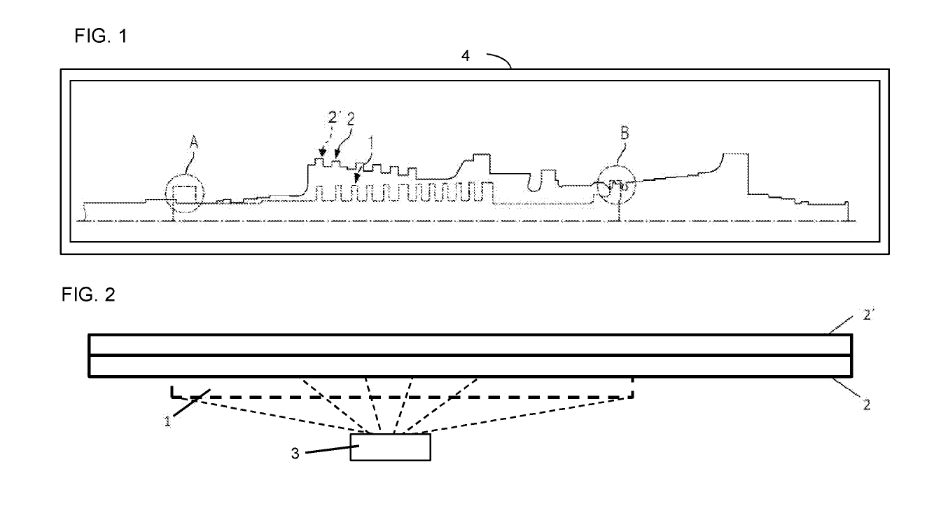

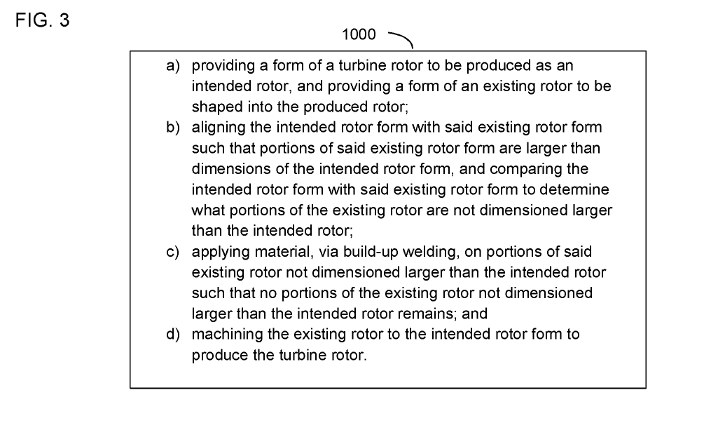

In one exemplary embodiment, e.g., the embodiment illustrated on FIG. 2, a controller 3 may be provided an operable connected to a display 4 for displaying to an operator or user a form of the steam turbine rotor to be produced 1, also referred to herein as the intended rotor form., aligned with one or more forms of an existing rotor 2 or similarly dimensioned material to be shaped into the rotor to be produced. It should be appreciated that the intended rotor form 1 may be a schematic layout of a new rotor or an existing rotor in operation and without any defects warranting repair. It should further be appreciated that the form of the existing rotor 2, 2′ may also be a schematic layout of any existing rotor or piece of material or materials available for being shaped into the intended rotor ready for service, i.e., the produced rotor. It should further be appreciated that one or more pieces of materials or rotors may be joined by any known means for joining, e.g., superalloy components, to create the existing rotor and subsequent existing rotor form 2, 2′ for being later shaped by a method 1000 (FIG. 3) into the produced rotor. Additionally or alternatively, the multiple pieces of materials may also be used to make multiple produced rotors via the claimed method. For example, FIG. 2 illustrates a top down view of two existing rotors or pieces of materials being predominantly larger dimensioned that the intended rotor and aligned with one another for producing multiple steam turbine rotors, via one application of the method 1000, and in accordance with the disclosure provided herein.

With continued reference to the figures and now FIG. 3, the method 1000 is provided. It should be appreciated that the method 1000 may be a method performed in the controller 3 via a software application stored in a memory and executed by a processing circuit. The software application may include a plurality of instructions for processing one more images or layouts, e.g., the intended 1 and existing 2 forms. For example, images of the existing rotor may be captured by any known imaging device, e.g., an image recorder, and uploaded to the controller' 3 storage or other storage device operably connected to the controller. Instructions for displaying the captured image and aligning the captured image with other images of existing rotors or intended rotors to be produced. The images being displayed via the controller are presented as forms via the software application.

In a first step a) of the method, the existing steam turbine rotor 2 is provided. The existing rotor 2 may be a salvaged or a spare rotor being in stock. Additionally or alternatively, the existing rotor 2 may also be assembled of two or more existing steam turbine rotors or pieces of materials, e.g., superalloy components, which are joined to each other in order to form the existing rotor 2, e.g. by means of welding. It should be appreciated that when necessary, the existing steam turbine rotors may be modified e.g., shortened, prior to being joined for creating the existing rotor.

In a second step b) a form of the existing rotor 2 is compared with a form of the intended rotor 1 and a position of the intended rotor 1 is chosen within the existing rotor 2 taking into consideration production-oriented aspects, in particular the amount of material to be applied in step c) and/or the amount of material to be machined in step d). The comparison of the forms of the existing rotor 2 and the intended rotor 1 as well as the choice of the position of the intended rotor 1 within the existing rotor 2 may be supported by a suitable computer program, by means of which the intended rotor 1 can be fitted in the existing rotor 2 as indicated in the figure.

In this step, it should be appreciated that an image or layout of the existing rotor is captured once the existing rotor is ready for production, e.g., once the multiple pieces have been joined in an embodiment where multiple pieces are used to create the existing rotor. Once the existing rotor is ready, the image of the rotor is captured and uploaded to the controller for alignment with the intended rotor, which may also be captured and uploaded in a similar manner to the existing rotor or the intended rotor may be preloaded into the controller, e.g., from a manufacture of the steam turbine or rotor.

With continued reference to the exemplary embodiment of FIG. 1, at portions A and B, where not enough material is present for machining the intended rotor 1 at the chosen position, it is necessary to augment the dimensions of the existing rotor 2 with a corresponding amount of weld material in an additional step c) by means of a build-up welding. In this step, the software application may include instructions to display those portions A and B as compared to the intended rotor, and to calculate the amount of build-up material that may be necessary to build up portions of the existing rotor form to the dimensions represented by the intended rotor form. Upon determining the amount of build-up modification needed, the controller may display that the existing rotor is properly shaped to match or substantially match the dimensions of the intended rotor so that actual production of the intended motor may begin.

It should further be appreciated, that those portions of the existing rotor form that are illustrated as exceeding portions of the intended rotor form may in a further step d) be machined to meet or be approximate to the dimensions of the intended rotor. Machining of the existing rotor may be by means of turning and/or milling and/or grinding or any other means know to persons of ordinary skill in the art.

One main advantage of the method is that it is superior to purchasing a new forging from both a cost and schedule perspective. It is also preferable to performing large-scale weld repairs where a significant percentage of the forging would have to be restored.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the terms “comprising”, “including”, and “having”, are open-ended and does not exclude other elements or steps; and the use of articles “a” or “an” does not exclude a plurality.

We claim:

1. Method for producing a turbine rotor out of an existing forged and machined steam turbine rotor, comprising:
a) providing a form of the turbine rotor to be produced as an intended rotor, and providing a form of the existing rotor;
b) positioning the intended rotor form with said existing rotor form such that portions of said existing rotor form are larger than dimensions of the intended rotor form, and comparing the intended rotor form with said existing rotor form to determine what portions of the existing rotor are not dimensioned larger than the intended rotor;
c) applying material, via build-up welding, on portions of said existing rotor not dimensioned larger than the intended rotor such that no portions of the existing rotor not dimensioned larger than the intended rotor remains; and
d) machining the existing rotor to the intended rotor form to produce the turbine rotor.

2. Method according to claim 1, wherein positioning of the intended rotor is based upon production-orientated aspects, in particular the amount of material to be applied in step c) and/or the amount of material to be machined in step d).

3. Method according to claim 1, wherein the machining in step d) is performed by means of turning and/or milling and/or grinding.

4. Method according to claim 1, further comprising:
providing at least a second existing forged and machined steam turbine rotor joined to the first existing turbine rotor prior to step b).

5. Method according to claim 4, wherein the existing rotors are joined to each other by welding.

6. Method according to claim 4, wherein at least one of the existing rotors is shortened prior to being joined.

7. Method according to claim 5, wherein at least one of the existing rotors is shortened prior to being joined.
